(19) United States
(12) Patent Application Publication
(10) Pub. No.: US 2006/0089073 A1
(43) Pub. Date: Apr. 27, 2006

(54) Moisture transmissive laminate

(76) Inventor: Robert T. Sobieski, Toluca (MX)

Correspondence Address: Chief Intellectual Property Counsel;OMNOVA Solutions Inc., 175 Ghent Road, Fairlawn, OH, 44333-3300, US

(21) Appl. No.: 11/256,238

(22) Filed: Oct. 21, 2005

Related U.S. Application Data
(60) Provisional application No. 60/621,963, filed on Oct. 25, 2004.
(60) Provisional application No. 60/648,574, filed on Jan. 31, 2005.

(51) Int. Cl. B32B 27/12

(52) U.S. Cl. 442/394

(57) ABSTRACT

A laminate having high moisture vapor permeability includes a moisture vapor transmissive monolithic film layer and a water permeable support layer. The laminate has a moisture permeability of at least about 25 perms as measured by the Water Method and a Hydrostatic Head of at least about 20 cm.

### CROSS-REFERENCE TO RELATED APPLICATIONS

This application claims benefit to U.S. provisional patent appl. No. 60/621,963 filed Oct. 25, 2004, and U.S. provisional patent appl. No. 60/648,574 filed Jan. 31, 2005.

### BACKGROUND

1. Field of the Invention

The invention relates to laminates including wallcoverings, more particularly to laminates that permit moisture vapor to pass therethrough.

2. Background Information

Sheets made from poly(vinyl chloride) (hereinafter “PVC” or “vinyl”) are known to be moisture impermeable. In fact, this feature is used widely to advantage by architects, environmental engineers, builders, and the like in such applications as geo-membranes (e.g., pond liners), roofing membranes, shower pan liners, etc., where the prevention of moisture moving into or away from an area is undesirable.

Because of their printability and durability, PVC sheets also have been used as decorative coverings, particularly as decorative laminates and wallcoverings. These decorative materials generally have the same moisture impermeability characteristics as the aforementioned membranes put to more industrial-type usages. While moisture impermeability can be desirable in many wallcovering applications, such as in bathrooms and kitchens, it may be less desirable under other circumstances.

A building that is poorly constructed (e.g., has exterior leaks, improperly designed air conditioning vents and returns, etc.) and/or has negative air flow conditions can have significant moisture condensation, including in or behind walls. The low moisture permeability of PVC sheets can inhibit the transport of moisture and condensate out of the wall and into the room. If the rate of transport falls below the rate at which moisture permeates through or into the building walls, moisture can accumulate behind the wallcovering.

Water trapped behind a wallcovering may assist or enable growth of microbes such as molds and mildew in the wall or wallcovering paste. Many commonly used pastes contains organic materials, such as starch or its byproducts, that can serve as nutrients for sustaining the growth of molds and mildew. Such growth commonly is accompanied by staining or discoloration of the wallcovering and the presence of offensive odors.

The breathability or moisture permeability of wallcoverings often is expressed quantitatively in units of “perms,” a term used in the industry corresponding to grams of moisture (water) that pass through or permeate a sample (e.g., a wallcovering) per square meter per hour under specified conditions. Moisture permeability commonly is evaluated by a test such as, e.g., ASTM Standard Test Method E96. Conventional vinyl wallcoverings generally have a moisture permeability of about 1 or 2 perms.

One approach to alleviate or remedy the problem of water containment in building construction involves alternative wallcovering constructions. For example, perforated wallcoverings can provide enhanced moisture vapor transmission, i.e., they are considered breathable. However, this benefit can come at the cost of also making the wallcovering permeable to other agents such as microbes, spores, odor, and liquids. Additionally, perforation holes can act as collection zones for dust. In certain circumstances, porous surfaces provided by perforation might capture and, if not properly cleaned or maintained, provide places for cultivation of microbial growth.

### SUMMARY

The present invention provides a laminate that includes a moisture vapor transmissive monolithic film layer and a water permeable support layer. The laminate has a moisture permeability of at least about 25 perms as measured by the Water Method and a Hydrostatic Head of at least about 20 cm.

The laminate is highly permeable to moisture but, at the same time, can act as a barrier to liquids and to microbes, bacteria, spores and the like. The laminate additionally can afford exceptional strength characteristics and aesthetics. It presents an excellent surface for printing and embossing.

The water permeable support layer can be selected to provide dimensional stability and integrity. Dimensional stability is particularly advantageous for retention of the laminate on an intended substrate (such as a wall) without stretching, buckling or puckering when exposed to environmental challenges such as physical impact or friction or exposure to liquids, either by accident or in an intentional cleaning process. Internal integrity is advantageous not only for durability purposes but also to facilitate removal of the laminate from a substrate. Preferably, the laminate exhibits sufficient tear and tensile strength to be removed as a single sheet.

The laminate can be used to enhance the perm value of a substrate to which it is attached because of the high moisture transmission that it can achieve or provide. While not being bound by theory, the laminate is believed to wick moisture so as to enhance the moisture transfer properties of the substrate as compared to a like, uncovered substrate.

The moisture vapor transmissive monolithic film layer can be disposed over an image which can be formed on, e.g., the water permeable support layer. This embodiment advantageously provides a moisture vapor transmissive laminate having an image protected from environmental assault, such as by water or physical frictional contact.

### BRIEF DESCRIPTION OF THE DRAWINGS

The accompanying drawings illustrate several aspects of the invention and together with a description of the embodiments serve to explain the principles of the invention. A brief description of the drawings is as follows:

FIG. 1 is an edge view of a wallcovering laminate according to the present invention in which a moisture vapor transmissive monolithic film layer is laminated to a fabric water permeable support layer.

FIG. 2 is an edge view of another embodiment of a wallcovering laminate according to the present invention in which a moisture vapor transmissive monolithic film layer is adhered to a fabric water permeable support layer.

FIG. 3 is an edge view of another embodiment in which a moisture vapor transmissive monolithic film layer is affixed by a first adhesive layer to water absorbent layer which, in turn, is affixed to a fabric water permeable support layer by a second adhesive layer.

FIG. 4 is an edge view of another embodiment of a wallcovering laminate according to the present invention in which a moisture vapor transmissive monolithic film layer is laminated to a water permeable support layer that is a perforated film.

### DETAILED DESCRIPTION OF ILLUSTRATIVE EMBODIMENTS

“Monolithic,” “non-porous” and “continuous,” as used herein, each generally refers to the lack of small holes, openings or gaps that provide a direct pathway for liquid moisture to flow, as contrasted with molecular level pathways that can be present for diffusion of moisture. A wallcovering is considered to be continuous if it has a Hydrostatic Head of at least about 20 cm. (Hydrostatic Head can be measured using a Souter hydrostatic test apparatus in accordance with AATCC 127 test protocol.)

The laminate preferably has an Elmendorf tear strength, as determined by CCC-T-191b 5132 test method, of at least about 45 N×45 N (10 lbs×10 lbs), preferably at least about 65 N×65 N (15 lbs×15 lbs) and a Tensile breaking strength, as determined by CCC-T-191b 5100 test method, of at least about 90 N×90 N (20 lbs×20 lbs), preferably at least about 110 N×110 N (25 lbs×25 lbs).

The wallcovering laminate also can provide an outermost surface that is highly cleanable as compared to wallcoverings that rely on perforation or a non-continuous (e.g., woven or non-woven) construction to provide breathability characteristics.

In the description that follows, the laminate is described in the form of a wallcovering. This is intended in a non-limiting sense because the described aesthetic, protective sheet material cam be applied to substrates such as a floors, ceilings, container surfaces, etc., in addition to walls. Such a covering is particularly useful and advantageous for decorating walls in highly humid geographic areas.

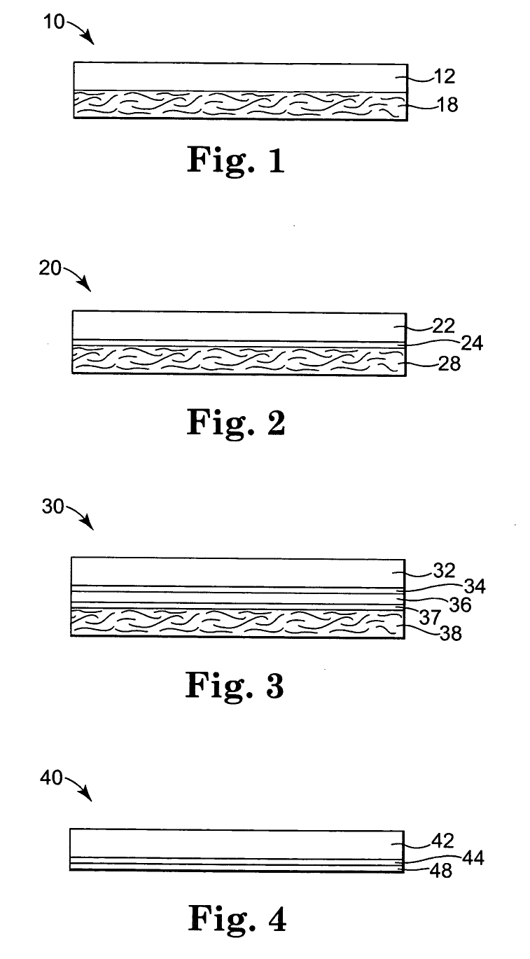

Turning now to the drawings, wherein like numbers represent like parts, FIG. 1 is an edge view of a wallcovering laminate 10 having moisture vapor transmissive monolithic film layer 12 laminated to water permeable support layer 18. As shown, monolithic film layer 12 is laminated to support layer 18 by a thermal lamination process; one or both of monolithic film layer 12 and support layer 18 are heated to a tacky state so that, when they are contacted, the layers adhere. Alternatively, monolithic film layer 12 can be applied to support layer 18 in an extrusion process, such as a blown or cast film-making process. In another alternative, monolithic film layer 12 can be laminated to support layer 18 in a coating process wherein the polymer of the film layer 12 is applied to support layer 18 as a dispersion or solution and cured to form a monolithic film layer in situ.

Moisture vapor transmissive monolithic film layer 12 can be made of a polymeric film material that has a Hydrostatic Head of at least about 20 cm and a moisture vapor transmission rate, when one mil of film is tested using the Upright Cup method of ASTM E96B at 23° C. and 50% relative humidity (hereinafter “RH”), of at least about 200, preferably at least about 400, and more preferably at least about 1000 g/m²/24 hr. Film materials that can satisfy this requirement include those made from thermoplastic resins containing a relatively high content of hydrophilic components. Examples of such resins include block copolyether esters, block copolyether amides, polyurethanes, and combinations thereof. Non-limiting exemplary film materials include thermoplastic polyurethanes such as Estane™ TPUs (Noveon, Inc.; Cleveland, Ohio), including film grades such as 58237, 58245, X-4751, X-4986 and X-4988; polyether-block co-polyamide polymers such as Pebax™ resins (Arkema Inc.; Philadelphia, Pa.); Hytrel™ thermoplastic polyester elastomers (DuPont; Wilmington, Del.); and Sympatex™ hydrophilic polyester block copolymer film (Sympatex Technologies, GmbH; Wuppertal, Germany). Examples of dispersion or solution resin materials that can form a monolithic film layer after being coated and dried or cured include Performax™ resins (Noveon, Inc.), including the 210 grade resin.

Monolithic film layer 12 can incorporate opacifying agents such as TiO₂. Additionally or alternatively, monolithic film layer 12 can be tinted to a desired color.

Monolithic film layer 12 can have a thickness of from about 0.01 to about 0.1 mm (0.5 to 5 mils), preferably from about 0.25 to about 0.075 mm (1 to 3 mils).

Water permeable support layer 18 as shown is a fiberglass scrim that provides structural support for the wallcovering laminate and is fully permeable to water. Water permeable support layer 18 can be provided as a fabric. Preferred fabrics are woven webs, such as drill, scrim, cheesecloth, and so forth, or knit fabrics. Preferably, the woven fabric has a thread count of 30×20 to about 40×40, more preferably from about 32×22 to about 36×36, and is made of fibers of about 200 to about 400 denier. Suitable thicknesses for the fabric can vary, although thicknesses ranging from 0.1 to 1.0 mm (about 4 to about 40 mils) are generally desirable and from 0.2 to 0.6 mm (about 8 to about 25 mils) being preferred. Fabric weight for the fabric also can vary considerably, although fabric weights of from 20 to 360 g/m² (about 1 to about 15 oz/yd²) are generally desirable and from 60 to 240 g/m² (about 3 to about 10 oz/yd²) being more preferred.

Alternatively, water permeable support layer 18 can be provided as a non-woven fabric, preferably a non-woven cloth made by standard web forming processes such as wet laying, dry laying (including air laying with optional carding steps) and direct laid (including spun-bond, melt-blown and film fibrillation processes). Non-woven fabrics also may be prepared by hydroentanglement processes; see, e.g., U.S. Pat. No. 3,537,945. The non-woven fabrics preferably have thread counts, denier and density the same as, or as similar as the different configuration allows, to the woven fabrics discussed above.

Water permeable support layer fabrics can be made of cellulosic fiber such as cotton or wool; synthetic fibers such as nylon, polyester, aramid, polyolefin, rayon or acrylic fibers; mineral fibers such as glass; cords; or combinations thereof. Blends of cellulosic and synthetic fibers can be used, with a preferred blend containing at least about 10% by weight of at least one synthetic polymeric fiber to provide the fabric with better strength properties such as improved tear resistance. The total fiber content of the fabric can be at least about 20-35% by weight of cellulosic fibers to provide improved absorption and adhesion character (i.e., the ability to adhere the wallcovering to a wall or other substrate using a conventional wallcovering adhesive). Particularly preferred are blends that include from about 65 to about 80% by weight polyester fibers and from about 20 to about 35% by weight cellulosic fibers.

Water permeable support layer fabrics can be hydrophilic or hydrophobic, preferably hydrophilic. While not being bound by theory, providing a hydrophilic layer in close proximity to monolithic film layer 12 is believed to enhance the moisture removal properties of wallcovering laminate 10 with respect to moisture that is present in the substrate or construction to which wallcovering laminate 10 is applied.

Water permeable support layer 18 can be a fabric that has been treated to enhance its water absorbing properties. Water permeable support layer 18 preferably can absorb more than about 10%, more preferably more than about 100%, of its own weight in water. Compositions preferred for treating support layer 18 to enhance water absorption include carboxylated styrene/butadiene compositions such as GenFlo™ 3060 and GenFlo™ 3810 (OMNOVA Solutions Inc.; Fairlawn, Ohio); poly(acrylic acid) compositions such as GOOD-RITE™ K-700 (meth)acrylate polymers (Noveon, Inc.); and the like. The treating composition can include fire retardants such as brominated materials, phosphorus materials,; and other flame retardants such as those based on antimony oxides, zinc borates, aluminum trihydrates, and the like. Treating layers of the wallcovering with combinations of various flame retardant materials is specifically contemplated.

Where support layer 18 is a fabric, it advantageously provides a surface that is conducive to enhancing stripping (removal) of wallcovering laminate 10 from a substrate.

FIG. 2 is an edge view of a wallcovering laminate 20 that includes moisture vapor transmissive monolithic film layer 22 affixed by adhesive layer 24 to water permeable support layer 28. Adhesive layer 24 can be continuous or discontinuous.

Adhesive may be prepared from any combination of homo- or co-polymers, oligomers or blends thereof to produce a polymeric composition containing polyacrylates, polyolefins, silicone adhesives, polyvinyl ethers, polyesters, and/or polyurethanes. Adhesive layer 24 can include a hydrophilic adhesive that facilitates moisture vapor transfer through wallcovering laminate 20. Alternatively, adhesive layer 24 can include a hydrophobic adhesive that is preferably provided in discontinuous form to provide open regions where moisture vapor can readily traverse the wallcovering laminate.

In one embodiment, adhesive layer 24 includes an adhesive including highly hydrophilic components, which are believed to enhance the moisture vapor transmission properties of the overall wallcovering laminate. An example of such an adhesive formulation is an acrylate-based adhesive that includes hydrophilic mer units, such as N-vinyl pyrrolidone and/or methoxy polyethylene oxide acrylate, in the adhesive polymer. Suitable adhesives may be formulated using, for example, Permax™ T-1201 and/or 100 waterborne polyurethane dispersions (Noveon, Inc.).

Adhesive layer 24 further can provide bonding to one another of fibers of support layer 28, thereby providing structural support for the overall wallcovering laminate. In certain embodiments, adhesive may be applied by spray or other discontinuous manner to adhere fibers throughout the web in addition to bonding monolithic film layer 22 to support layer 28; in this embodiment, adhesive may or may not appear as a discrete monolithic layer as represented in FIG. 2, but rather can be present in substantial conformity to the fibers of water permeable support layer 28. Intermediate configurations of adhesive with respect to monolithic film layer 22 and support layer 28 can be readily envisioned.

FIG. 3 is an edge view of a wallcovering laminate 30 including moisture vapor transmissive monolithic film layer 32 affixed by first adhesive layer 34 to water absorbent layer 36 which, in turn, is affixed by second adhesive layer 37 to water permeable support layer 38.

Water absorbent layer 36 preferably can absorb between 10 and 100% of its own weight in water and does not act as a reservoir. Rather, water absorbent layer 36 preferably acts to encourage the flow of moisture vapor through laminate 30.

Examples of materials from which water absorbent layer 36 suitably can be formed include compositions that include polymers having significant amounts of hydrophilic functionality covalently incorporated within the polymer. Additional such materials include resin blends comprising significant amounts of hydrophilic polymers. Examples of such hydrophilic functional polymers include selected acrylate polymers having hydroxy or amine functionalities, poly(N-vinyl lactams), polyacrylamides, polysaccharides, natural and synthetically modified alginates, guar gums, natural and synthetically modified celluloses, chitosan, chitin, polyoxyalkylenes, polyvinyl alcohols and mixtures thereof.

Additional exemplary materials from which water absorbent layer 36 can be formed include compositions that include non-polymeric hydrophilic components at least partially entrained within the composition. Exemplary hydrophilic components include glycerol, propylene glycol, poly(ethylene) glycol and polypropylene, sorbitol, erthyritol, threitol, ribotol, arabinitol, xylitol, allitol, talitol, mannitol, glucitol, glactitol, iditol, pentaerythritol, heptitol, octitol, nonitol, decitol, dodenitol, styracitol, polyalitol, D-fructose; 1,4 anhydro-D-mannitol; 1,4 anhydro-D-glucitol; pentose, hexose; heptose; poly(ethylene) glycol ether; polypropylene glycol ether; and mixtures thereof.

The matrix of water absorbent layer 36 can be in the form of a self-supporting film or a gel layer requiring the presence of water permeable support layer 38 for positional stability in wallcovering laminate 30.

FIG. 4 is an edge view of a wallcovering laminate 40 that includes moisture vapor transmissive monolithic film layer 42 affixed by adhesive layer 44 to water permeable support layer 48 which is a perforated film having sufficient perforations to provide a desired level of permeability. The material used to form the film of support layer 48 can be hydrophilic or hydrophobic. Examples of polymeric sheet materials that can be used to provide a perforated water permeable support layer include PVC, polyamide, acrylic, nylon, thermoplastic polyolefins such as polyethylene and polypropylene, polyethylene terephthalate, polybutylene terephthalate and other polyesters, ethylene/styrene copolymers, polycarbonates, and combinations thereof.

Perforations for support layer 48 can be provided in any desired manner, such as by a mechanical perforation apparatus. Mechanical perforations typically are imparted by a roll of metal spikes that impinge the sheet material and a supportive rubber blanket roll. Holes provided by mechanical perforation typically have a mean diameter of about 0.5 mm or larger, and are provided in a pattern of about 15-30 holes/cm². Preferred thicknesses for support layer 48 when provided as a perforated film are from 0.1 mm to 1.0 mm (about 4 to about 40 mils), with average thicknesses of from 0.2 mm to 1.0 mm (about 8 to about 40 mils) being preferred. The perforations can be imparted in a predetermined pattern such as a uniform pattern evenly spaced throughout the sheet, a recurring pattern having more perforations at one portion than another portion with repetitions of the pattern at different locations on the sheet, a varied pattern having more perforations at one portion than another portion with no repetition of the pattern on the sheet, or a random pattern of perforations on the sheet.

Preferably, the materials selected to form the wallcovering laminate of the present invention are PVC-free and are low in content or substantially free of volatile organic compounds that would be emitted over the use life of the ultimate wallcovering product. Moisture vapor transmissive monolithic film layer materials in particular advantageously may be selected to incorporate limited amounts of organic materials that can migrate, thereby raising air quality concerns and/or stability of printed material on the surface of the monolithic film layer.

Examples of other conventional components which can be incorporated into one or more layers of the laminate include ultraviolet light absorbers, fungicides, Ba—Cd—Zn stabilizers, Ba—Cd stabilizers, Zn stabilizers, dibasic lead phosphite, antimony oxides, and pigments such as TiO₂, red iron oxide, phthalocyanine blue or green, and the like. Preferred stabilizers are Cd-free or Cd— and Ba-free stabilizers. The pigments and other additives or compounding ingredients are used in effective amounts to control color, mildew, stabilization, etc.

One or more layers of the wallcovering can be provided with a filler component as either a treatment external to the layer, or mixed in as an internal ingredient of the layer. Such filler can provide opacity for the wallcovering, and preferably provides inexpensive selectivity of the overall weight of the wallcovering. Examples of preferred fillers include BaSO₄, CaCO₃, zinc borate, hydrated aluminum, and the like.

The wallcovering can have a moisture permeability, as measured by ASTM E96 (water method) of at least about 25 perms, preferably at least about 40 perms, and more preferably at least about 60 perms.

The wallcovering generally can be printed with any desired design or pattern using conventional printing techniques. Preferably, materials used for printing are inks that do not adversely affect the moisture vapor transmissive properties of the overall wallcovering.

The moisture vapor transmissive monolithic film layer preferably provides a continuous, smooth appearance. Alternatively, it can be embossed to provide an aesthetic texture as desired using conventional embossing or texturing techniques. The exposed surface of the wallcovering laminate can be provided with a printed decorative design or pattern having smooth, sharply defined edges providing an aesthetic appearance at least comparable to conventional wallcoverings.

Known lamination processes can be used to provide the wallcovering laminate. A water permeable support layer material, such as a fiberglass scrim, of a desired density and weight can be treated with a hydrophilic material in a pad coating operation to provide the desired integrity, hydrophilicity and weight properties of the water permeable support layer. Adhesive can be applied to one major surface of the water permeable support layer using any appropriate coating process, such as knife coating, reverse roll coating, pad coating, padded gravure coating, and rotary screen coating, with a knife over roll coating process being preferred; the adhesive layer preferably is substantially continuous. A moisture vapor transmissive monolithic film layer can be affixed to the water permeable support layer by contacting it with the adhesive. Alternatively, a dispersion or solution resin material can be coated on the water permeable support layer to create a monolithic film layer thereon. Any coating process that will result in formation of a monolithic film layer can be used, such as knife coating, reverse roll coating, pad coating, padded gravure coating, and rotary screen coating. The exposed surface of the monolithic film layer optionally can be embossed to provide a texture, such as a simulated leather grain.

After manufacture of the laminate, the exposed face thereof can be printed to form desirable decorative patterns and designs. Suitable inks are known and can be applied by various methods of printing such as by gravure, flexography, screen printing, jet printing, web printing, etc. The printing operation may be repeated many times, as needed, to vary and/or overlay the colors and designs.

The water permeable support layer can be printed to provide desirable decorative patterns and/or designs (hereafter “image”) before the printed side is contacted with a monolithic film layer, either by a coating operation or by lamination of a pre-formed film. The monolithic film layer thus can protect the image from environmental assault such as by liquid water or physical frictional contact. The construction of this embodiment can afford an additional degree of flexibility in ink selection due to the image being protected; thus, inks that otherwise might not be suitable for certain applications due to sensitivity to water or other materials, or inks that are not suitable for certain polymeric substrates, can be used in challenging interior environments. Examples of inks that can be used include the nitrocellulose inks, sensitive acrylic inks, and dye sublimation inks.

In either of the foregoing embodiments, the image can be a color, a pattern of one or more colors, a representation of figures and the like, and/or text.

The wallcovering laminate may be applied to a substrate using an adhesive, preferably a water-based adhesive to facilitate moisture passage from the substrate through the wallcovering and into the room. An adhesive is considered to be water-based if, in a non-emulsion system, it contains water in an amount sufficient to act a solvent for the non-water adhesive components; in an emulsion system, it is water-based if sufficient water is present to act as one of the phases in the emulsion system. In adhesives wherein water is acting as a solvent, water preferably is present as the majority component of the adhesive composition; in emulsion systems, water preferably is the continuous phase of the emulsion. Most preferably, the adhesive includes hydrophilic components to facilitate transmission of moisture. Examples include PRO-880 or PRO-732 adhesives (Roman Decorating Products; Calumet City, Ill.). Additional preferred adhesives include starch based adhesives.

The wallcovering can be provided in prepasted form, e.g., in roll form with adhesive already coated on one side of the wallcovering. The considerations discussed above apply similarly to the selection of adhesive for this type of embodiment.

The wallcovering laminate can be provided in sheet dimensions appropriate for use as a wallcovering material. The wallcovering laminate can be provided in roll form suitable for residential application and having a lengthwise dimension of at least about 7.5 or about 9 m (˜24 or ˜30 ft.) or can be provided in roll form suitable for commercial application and having a width of about 1.2 or about 1.35 m (˜48 or ˜54 in.) and a length of at least about 9 m (˜30 ft.).

The wallcovering laminate can have a total weight of from about 120 to about 240 g/m² (5-10 oz/yd²) thereby qualifying as a Type I commercial wallcovering or can have a total weight of from about 260 to about 360 g/m² (11-15 oz/yd²) thereby qualifying as a Type II commercial wallcovering.

Surprisingly, a substrate to which the wallcovering laminate is attached may have enhanced moisture transfer properties compared to a like substrate without such a laminate attached. More specifically, certain substrates such as walls that include wallboard have inherently limited moisture transfer properties due to their physical configuration and material constitution. Applying a wallcovering as described herein can enhance the moisture transfer properties of such a substrate beyond that which can be achieved by the substrate by itself. While not being bound by theory, the wall-covering construction described herein is believed to wick moisture out of and away from the substrate, thereby improving moisture transfer. Because of its relatively high moisture transmission, the wallcovering aids in controlling or diminishing moisture collection, specifically between the wallcovering and a wall to which it is applied.

Mold can grow at above 60% RH. Under certain conditions, conventional inner wall constructions can exceed this level of RH, leading to undesired mold and/or fungus growth. A gypsum wallboard, standard stud inner wall construction having attached thereto the wallcovering laminate can maintain, under ordinary construction conditions, a RH below about 60%, preferably below about 40%.

The present wallcovering laminates can provide particular advantage when applied to surfaces expected to be exposed to a high degree of moisture or humidity, such as in kitchens, baths and the like, or in humid areas or in humid climates.

Test Protocols

Perms are calculated in accordance with ASTM Standard Test Method E96, which describes the determination of water vapor transmission of materials through which the passage of water vapor may be of importance. Two methods are provided in ASTM E96: the Desiccant Method and the Water Method. Unless otherwise indicated, both of these methods evaluate the permeability of the sample as a free film (i.e. not adhered to a substrate) and are evaluated at a temperature of 23° C. with a dish having a mouth area of about 6 cm (2.5 in.).

In the Desiccant Method, a test specimen is sealed to the open mouth of a test dish containing desiccant, and the assembly placed in a controlled atmosphere. Periodic weighings determine the rate of water vapor moving through the specimen into the desiccant.

In the Water Method, the dish contains distilled water and the weighings determine the rate of vapor movement through the specimen from the water to the controlled atmosphere.

For purposes of the present invention, perm values are reported in inch-pound units. One perm represents passage of one grain (0.065 g) of water per square foot of material per hour under a pressure of one inch of mercury (1 perm=1 grain/(ft²·h·in Hg)=7.65×10⁻⁶ g/(m²·s·mm Hg).

All patents, patent documents, and publications cited herein are incorporated by reference as if individually incorporated. Unless otherwise indicated, all parts and percentages are by weight and all molecular weights are weight average molecular weights. The foregoing detailed description has been given for clarity of understanding only; no unnecessary limitations are to be understood therefrom, and the invention is not limited to the exact details shown and described, for variations obvious to one skilled in the art are included within the invention defined by the claims.

That which is claimed is:

1. A laminate useful as a wallcovering comprising:
a) a moisture vapor transmissive monolithic film layer;
b) a water permeable support layer; and
c) optionally, a water absorbent layer disposed between said monolithic film layer and said support layer,
said laminate having a moisture permeability of at least about 25 perms as measured by the Water Method and a Hydrostatic Head of at least about 20 cm.

2. The laminate of claim 1 wherein said moisture vapor transmissive monolithic film layer comprises a polyurethane or a polyether-block co-polyamide polymer film.

3. The laminate of claim 1 wherein said moisture vapor transmissive monolithic film layer has a thickness of from about 0.5 to about 5 mils.

4. The laminate of claim 1 wherein said water permeable support layer is a fabric.

5. The laminate of claim 4 wherein said fabric has a weight of from about 3 to about 10 oz/yd².

6. The laminate of claim 4 wherein at least one of said water permeable support layer and said water absorbent layer is capable of absorbing more than about 10% of its own weight in water.

7. The laminate of claim 1 wherein said water absorbent layer comprises at least one of a hydrophilic functional polymer and a hydrophilic component.

8. The laminate of claim 1 wherein said water absorbent layer is a self-supporting film or a gel layer.

9. The laminate of claim 1 wherein said water permeable support layer is a perforated film.

10. The laminate of claim 1 wherein said moisture permeability is at least about 60 perms.

11. The laminate of claim 1 further comprising an image disposed below said moisture vapor transmissive monolithic film layer.

12. The laminate of claim 11 where said image is formed on said water permeable support layer.

13. A method of providing a surface having high moisture transfer properties, comprising affixing the laminate of claim 1 to a surface.

14. The method of claim 13 wherein said laminate is affixed to said surface by a water-based adhesive.

15. The method of claim 13 wherein said surface is a wall comprising wallboard.

16. The method of claim 15 wherein the relative humidity of the interior of said wall is maintained, under ordinary environmental conditions, below about 60% relative humidity.

17. A method of providing the laminate of claim 1 comprising laminating said moisture vapor transmissive monolithic film layer to said water permeable support layer.

18. The method of claim 17 further comprising printing an image on said water permeable support layer prior to said laminating step.

19. A method of providing the laminate of claim 1 comprising coating said water permeable support layer with a resin composition and allowing said composition to form said moisture vapor transmissive monolithic film layer.

20. The method of claim 20 further comprising printing an image on said water permeable support layer prior to said coating step.
